(19) United States
(12) Patent Application Publication
(10) Pub. No.: US 2018/0361676 A1
(43) Pub. Date: Dec. 20, 2018

(54) SYSTEMS AND METHODS FOR FORMING ADHESIVE BONDS

(71) Applicant: BEMIS ASSOCIATES, INC., Shirley, MA (US)

(72) Inventors: Stephen Topper, Barre, MA (US); Daryl Johnson, Fitchburg, MA (US); Jared Ide, Medford, MA (US)

(21) Appl. No.: 15/989,361

(22) Filed: May 25, 2018

Related U.S. Application Data
(60) Provisional application No. 62/511,536, filed on May 26, 2017.

(51) Int. Cl. B29C 65/52; C09J 7/21; D06M 17/08; B29C 65/48; A41D 31/02; A41H 43/04

(52) U.S. Cl. CPC B29C 65/526; C09J 7/21; D06M 17/08; B29C 65/4815; B32B 7/14; A41H 43/04; B32B 2262/0276; B32B 2262/062; B32B 2437/00; A41D 31/02

(57) ABSTRACT

A printing process is used to print a pattern of hot melt adhesive onto a release paper. The adhesive pattern can be transferred from the release paper and used to bond two substrates together. The adhesive pattern preferably includes a repeating pattern of discrete features, with each feature having a minimum dimension in a range up to about 5 to 10 mm.

### CROSS-REFERENCE TO RELATED APPLICATIONS

This application claims the benefit of U.S. Provisional Patent Application No. 62/511,536, filed May 26, 2017, the entire contents of which are incorporated by reference herein.

### TECHNICAL FIELD

In various embodiments, the invention relates to adhesive materials and, more particularly, to systems and methods for printing and using patterns of adhesive.

### BACKGROUND

Hot melt adhesives (HMAs), such as thermoplastic polyurethanes (TPUs), are commonly used to form bonds between two or more substrates, such as fabrics, foams, plastics, and other composites and combinations. HMAs can exhibit high tensile strength, excellent flexibility and good abrasion resistance. HMA films can be used with a variety of manufacturing methods, ranging from hot-melt to flame lamination. Various welding operations, including ultrasonic, HF, RF and platen sealing, can be used to activate these films.

In certain applications, however, bonds formed with HMAs can be overly rigid and/or can lack breathability. Such bonds can cause performance issues in garment materials and in other applications where it is desirable for bond regions to be soft, flexible, and breathable.

### SUMMARY OF THE INVENTION

Embodiments of the systems and methods described herein relate to a printing process for printing patterns of adhesive on release paper, and using the printed patterns to form bonds between two substrates. Adhesive bonds formed with the printed adhesive patterns have several advantages. In garment applications, for example, the patterns improve breathability and softness and can influence modulus and recovery, while maintaining wash requirements, dry requirements, and peel force. Unlike solid adhesive films, which can restrict movement of fabric layers in or around bond regions, the adhesive patterns described herein generally allow fabric materials to stretch and recover. The adhesive patterns can have some visibility on the garment, so design aesthetics can also be improved. Further, openings and discontinuities in the adhesive patterns can permit the passage of air or water vapor, thereby improving breathability. The openings can also reduce the amount of adhesive required to form bonds, thereby resulting in a lighter weight product. Additionally or alternatively, by using the printing process, the need for cutting (e.g., die cutting) adhesive films to form the desired adhesive patterns can be reduced or eliminated. This can greatly simplify manufacturing processes and reduce waste.

In general, in one aspect, the subject matter of this disclosure relates to a method of printing an adhesive material. The method includes using a printing process to print a repeating pattern of hot melt adhesive onto a release paper. The repeating pattern defines a plurality of discrete features, with each feature having a minimum dimension in a range up to about 10 mm.

In certain examples, the printing process uses a gravure roll having cells that define the repeating pattern. The features can be or include adhesive regions and/or openings. The hot melt adhesive can be or include a thermoplastic polyurethane, a co-polyester, a polyolefin, a thermoplastic rubber, a polyamide, and any combination thereof. The repeating pattern can include a grid pattern. In some instances, the features can be or include rectangles, squares, diamonds, circles, triangles, and/or ovals. The features can be defined by or can be or include a plurality of parallel lines of the adhesive. In certain implementations, the hot melt adhesive covers from about 40% to about 75% of a printed area. The release paper can be or include a silicone coated release paper, a clay coated paper, and/or a plastic release liner, which can be or include at least one of polyethylene, polypropylene, and polyester. In preferred examples, the release paper is or includes a continuous web.

In another aspect, the subject matter of this disclosure relates to a gravure roll having a plurality of cells arranged in a pattern and adapted to be filled with hot melt adhesive. The pattern defines a plurality of discrete features, with each feature having a minimum dimension in a range up to about 10 mm.

In certain implementations, the hot melt adhesive can be or include a thermoplastic polyurethane, a co-polyester, a polyolefin, a thermoplastic rubber, a polyamide, and any combination thereof. The features can be defined by or can be or include the plurality of cells and/or regions between the plurality of cells. The features can be arranged in a grid pattern. The features can be or include rectangles, squares, diamonds, circles, triangles, and/or ovals. The features can be defined by or can be or include a plurality of parallel lines of the cells. The cells can cover from about 40% to about 75% of an outer surface of the gravure roll. In some instances, the gravure roll includes a polytetrafluoroethylene coating, a silicone coating, and/or a chrome plating.

In another aspect, the subject matter of this disclosure relates to an adhesive material. The adhesive material includes a release paper and a repeating pattern of hot melt adhesive disposed on the release paper. The repeating pattern defines a plurality of discrete features, with each feature having a minimum dimension in a range up to about 10 mm.

In certain implementations, the release paper is or includes a silicone coated release paper, a clay coated paper, and/or a plastic release liner, which can be or include polyethylene, polypropylene, polyester, or any combination thereof. The features can be or include adhesive regions and/or openings. The hot melt adhesive can be or include a thermoplastic polyurethane, a co-polyester, a polyolefin, a thermoplastic rubber, a polyamide, or any combination thereof. The repeating pattern can be or include a grid pattern. The features can be or include at least one of rectangles, squares, diamonds, circles, triangles, and/or ovals. The features can be defined by or can be or include a plurality of parallel lines of the adhesive. The hot melt adhesive can cover from about 40% to about 75% of a surface of the release paper. The release paper can be or include a continuous web.

In another aspect, the subject matter of this disclosure relates to a method of forming a breathable adhesive bond. The method includes transferring a pattern of hot melt adhesive from a release paper to a first substrate, and forming a bond between the first substrate and a second substrate with the pattern of hot melt adhesive. The pattern defines a plurality of discrete features, with each feature having a minimum dimension in a range up to about 10 mm.

In some examples, the hot melt adhesive is or includes a thermoplastic polyurethane, a co-polyester, a polyolefin, a thermoplastic rubber, a polyamide, and any combination thereof. The pattern can be or include a grid pattern. The features can be or include adhesive regions and/or openings. The features can be or include rectangles, squares, diamonds, circles, triangles, and/or ovals. The features can be defined by or can be or include a plurality of parallel lines of the adhesive. The hot melt adhesive can cover from about 40% to about 75% of a surface of the release paper. In some implementations, the release paper is or includes a silicone coated release paper, a clay coated paper, and/or a plastic release liner, which can be or include polyethylene, polypropylene, polyester, and any combination thereof. The first and second substrates can be or include garment materials. The bond can be or include a breathable bond. Transferring the pattern can include using heat and pressure. Forming the bond can include using heat and pressure.

In another aspect, the subject matter of this disclosure relates to a garment. The garment includes: a first garment layer; a second garment layer; and a pattern of hot melt adhesive bonding the first and second garment layers. The pattern defines a plurality of discrete features, with each feature having a minimum dimension in a range up to about 10 mm.

In certain examples, the first and/or second garment layers can include a fabric material. The hot melt adhesive can be or include a thermoplastic polyurethane, a co-polyester, a polyolefin, a thermoplastic rubber, a polyamide, or any combination thereof. The features can be or include adhesive regions and/or openings. The pattern can be or include a grid pattern. The features can be or include rectangles, squares, diamonds, circles, triangles and/or ovals. The features can be defined by or can be or include a plurality of parallel lines of the adhesive. The pattern of hot melt adhesive can form a breathable bond between the first and second garment layers.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic, side view of a process for printing an adhesive material on a web of release paper, in accordance with certain embodiments of the invention.

FIG. 2 is a schematic, cross-sectional, side view of a device for heating and pressing a combination of a release paper, a hot melt adhesive, and a substrate, in accordance with certain embodiments of the invention.

FIG. 3 is a schematic, cross-sectional, side view of a device for heating and pressing a combination of a first substrate, a hot melt adhesive, and a second substrate, in accordance with certain embodiments of the invention.

FIG. 4 is a schematic, top view of a pattern of adhesive, in accordance with certain embodiments of the invention.

FIG. 5 is a schematic, top view of a pattern of adhesive, in accordance with certain embodiments of the invention.

FIG. 6 is a schematic, top view of a pattern of adhesive, in accordance with certain embodiments of the invention.

FIGS. 7A-7H are schematic diagrams of features included in a pattern of adhesive, in accordance with certain embodiments of the invention.

FIG. 8 is a flowchart of a method of forming a bond using an adhesive pattern, in accordance with certain embodiments of the invention.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial, so long as the invention remains operable. Moreover, two or more steps or actions may be conducted simultaneously.

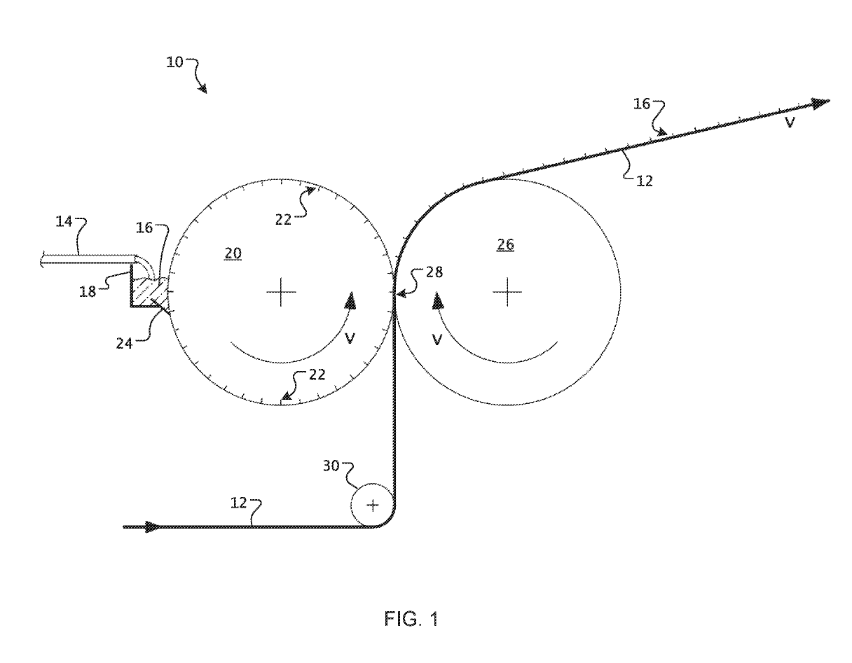

Referring to FIG. 1, in certain examples, a printing process 10 is used to print hot melt adhesive onto release paper 12. A nozzle or other adhesive delivery device 14 feeds adhesive 16 into a trough 18, which is preferably heated to maintain the adhesive 16 above a melting temperature and in a liquid state. The trough 18 is positioned against an engraved or gravure roll 20 that includes a pattern of cells 22 for receiving the adhesive 16. As the gravure roll 20 rotates at a velocity V, the cells 22 pass through the trough 18 and are filled with the adhesive 16. A doctor blade 24 scrapes excess adhesive 16 from the gravure roll 20, such that the cells 22 can remain filled with adhesive 16 and regions between or around the cells 22 can be wiped clean of the adhesive 16.

A rubber roll 26, also rotating at velocity V, is pressed against the gravure roll 20 to form a contact region or nip 28. A web of the release paper 12 is wrapped around a feed roller 30 and passes through the nip 28, where the adhesive 16 is transferred from the cells 22 to the release paper 12. To facilitate the transfer of adhesive 16 from the cells 22 to the release paper 12, the gravure roll 20 and the cells 22 can be coated with a low surface energy material, such as polytetrafluoroethylene (PTFE) or silicone. Alternatively or additionally, an outer surface of the gravure roll 20 and/or the cells 22 can be or include a plating of chrome or other metal. After exiting the nip 28, the release paper 12, which is traveling at velocity V, includes a pattern of adhesive 16 corresponding to the pattern of cells 22 on the gravure roll 20. The adhesive 16 on the release paper 12 is allowed to cool and crystallize. The release paper 12 with the adhesive 16 can be wound up in roll form and/or cut into sheets for subsequent use. Typical machine speeds (e.g., paper or web velocities) can range from about 2 m/min to about 100 m/min or more and may vary according to the adhesive being used and/or the pattern being printed. In alternative examples, a sheet-fed printing process can be used, in which the release paper 12 is passed through the nip in sheet form, rather than in web form. Additionally or alternatively, other printing processes besides gravure printing can be used, such as flexographic printing, offset printing, or ink jet printing.

In various instances, the adhesive 16 is or includes a hot melt adhesive. The adhesive 16 can be or include, for example, a TPU, a co-polyester, a polyolefin, a thermoplastic rubber, a polyamide, and any combination thereof. The adhesive 16 can have a melting temperature from about 50° C. to about 200° C., a viscosity at 160° C. from about 180 Pa-s to about 1200 Pa-s, and/or a viscosity at 190° C. from about 50 Pa-s to about 300 Pa-s. Exemplary TPUs are available from Bemis Associates Inc., of Shirley, Mass., U.S.A.

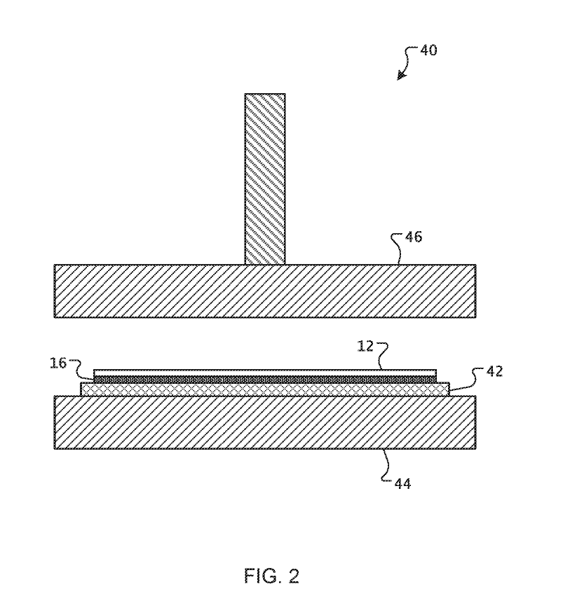

Referring to FIG. 2, in certain implementations, a heat press 40 is used to perform a tacking step in which the pattern of adhesive 16 is transferred from the release paper 12 to a substrate 42 (e.g., a fabric material). The substrate 42 can be positioned on a lower platen 44 of the heat press 40. The release paper 12 with the pattern of adhesive 16 can be positioned on top of the substrate 42, such that the adhesive 16 is in contact with the substrate 42. An upper platen 46 can be lowered and brought into contact with the release paper 12 to apply heat and pressure to the release paper 12, the adhesive 16, and the substrate 42. The heat and pressure can melt the adhesive 16 and cause the adhesive 16 to wet a surface of the substrate 42, such that the adhesive 16 forms a bond with the substrate 42. The upper platen 46 can then be returned to a raised position, and the substrate 42, the adhesive 16, and the release paper 12 can be allowed to cool, for example, by waiting about 1-2 minutes. When the release paper 12 is peeled away from the substrate 42, the adhesive 16 detaches from the release paper 12 and remains bonded to the substrate 42.

To facilitate the removal of the release paper 12 from the adhesive 16 and the substrate 42, the release paper 12 preferably has a lower surface energy and/or can include certain non-stick surface materials, such as silicone. The release paper 12 can be or include, for example, a silicone coated release paper, a clay coated paper, and/or a plastic release liner, which can be or include at least one of polyethylene, polypropylene, and polyester. Preferably little or no adhesive 16 remains on the release paper 12 after the release paper 12 is removed from the adhesive 16 and the substrate 42.

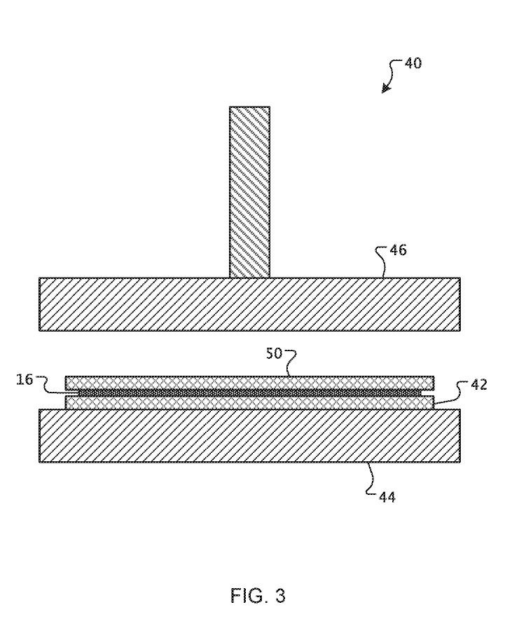

Referring to FIG. 3, in some implementations, the heat press 40 can be used to perform a bonding step in which a bond is formed between the substrate 42 and a second substrate 50 (e.g., a fabric material). For example, the second substrate 50 can be placed on top of the pattern of adhesive 16 bonded to the substrate 42, such that the adhesive 16 is positioned between the two substrates 42, 50. The upper platen 46 can be lowered and brought into contact with the second substrate 50 to apply heat and pressure to the second substrate 50, the adhesive 16, and the substrate 42. The heat and pressure can melt the adhesive 16 and cause the adhesive 16 to wet a surface of the second substrate 50, such that the adhesive 16 forms a bond with the second substrate 50. The upper platen 46 can then be returned to a raised position, and the second substrate 50, the adhesive 16, and the substrate 42 can be allowed to cool, thereby forming a bond between the two substrates 42, 50 with the pattern of adhesive 16.

In various examples, the bond formed between the two substrates 42, 50 can have a wide variety of shapes and sizes. For example, the adhesive can form a seam in which the two substrates 42, 50 are attached along a narrow strip (e.g., about 5-10 mm wide). Alternatively or additionally, the adhesive can form a laminate in which the two substrates 42, 50 are bonded over larger areas (e.g., greater than about 50 mm by 50 mm). Bond areas can be reinforced with stitches or other fasteners, if desired.

In some implementations, the heat press 40 can be a flat heat seal press, such as model DK2OSP, available from GEO KNIGHT AND CO. Inc., or model CS-026, available from H+H ASIA GROUP Ltd. Alternatively or additionally, the tacking step and/or the bonding step can be performed using a device other than a heat press, such as a hand iron or a continuous belt laminator. For example, the tacking step can be performed using a hand iron and the bonding step can be performed using a continuous belt laminator. Example continuous belt laminator devices include model HP-450MS, available from HASHIMA Co. Ltd., and model 335 032 (for narrow tacking or bonding), available from MACPI S.P.A. Table 1 presents exemplary minimum, maximum, and typical values for system parameters associated with the tacking and bonding steps.

TABLE 1
Exemplary system parameters for tacking and bonding.

| Parameter | Min. | Typical | Max. |
|---|---|---|---|
| Tacking Temperature (° C.) | 80 | 120 | 160 |
| Tacking Pressure in Heat Press (psi) | 40 | 60 | 80 |
| Tacking Pressure in Continuous Lamination (psi) | 5 | 18 | 30 |
| Tacking Time (seconds) | 3 | 7 | 10 |
| Bonding Temperature (° C.) | 90 | 130 | 170 |
| Bonding Pressure in Heat Press (psi) | 40 | 60 | 80 |
| Bonding Pressure in Continuous Lamination (psi) | 5 | 18 | 30 |
| Bonding Time (seconds) | 10 | 20 | 30 |

FIGS. 4-6 depict example patterns of adhesive 16 that can be printed and used with the systems and methods described herein. In general, each pattern includes a repeating arrangement of discrete or isolated features (e.g., circles, squares, rectangles, parallelograms, hexagons, polygons, diamonds, triangles, ovals, lines, company logos, alphanumeric characters, punctuation marks, symbols, and/or other shapes) that can be either regions of adhesive 16 or openings in the adhesive 16.

Each feature generally includes a characteristic length or minimum dimension that defines a scale of the feature. In some examples, the minimum dimension defines a scale of a distance between features. For example, a minimum dimension of a circle can be a diameter of the circle, a minimum dimension of a square or rectangle can be a length of a side of the square or rectangle (or a distance between opposite corners of the square or rectangle), and a minimum dimension of a line can be a width of the line. In one implementation, the minimum dimension is a length of a straight line that passes through the feature, from one side to an opposite side of the feature. The straight line preferably passes through a center point (e.g., a center of mass or a centroid) of the feature. In some instances, the minimum dimension is a cross-dimension of a feature, such as a minimum, maximum, or average cross-dimension or diameter. Example minimum dimensions for different feature shapes are presented in Table 2.

TABLE 2
Exemplary minimum dimension values for different feature types.

| | Minimum | Min. | Typical | Max. |
|---|---|---|---|---|
| Features | Dimension | (mm) | (mm) | (mm) |
| Circles | Diameter | 0.25 | 1.0-3.5 | 10 |
| Squares/Diamonds | Length of Side | 0.25 | 0.75-1.5 | 10 |
| Rectangles | Length of Side | 0.25 | 0.75-1.5 | 10 |
| Lines | Line Width | 0.25 | 0.5-2.0 | 10 |
| Ovals | Cross-Dimension | 0.25 | 1.0-3.5 | 10 |
| Triangles | Length of Side | 0.25 | 0.75-1.5 | 10 |

In various instances, the minimum dimension for a discrete feature is determined based on a compactness of the feature. Feature compactness can be determined, for example, based on a length L_{F} and a width W_{F} for the feature, where the length L_{F} is a maximum length of the feature and is greater than or equal to the width W_{F} (i.e., L_{F}/W_{F}≥1). In general, features having a low ratio R of the length L_{F} to the width W_{F} are compact features (e.g., squares, circles, or similar compact shapes) and features having a high ratio R are not compact (e.g., long and thin rectangles). In certain implementations, when the ratio R is less than or equal to a threshold value, a minimum dimension L_{MD} for the feature can be a diameter of a smallest circle that fully encloses the feature. Alternatively, when the ratio R is greater than the threshold value, the minimum dimension L_{MD} for the feature can be a diameter of a largest circle that fits fully within the feature. The threshold value for R=L_{F}/W_{F} can be, for example, about 3, about 5, about 10, or about 20. In some examples, regardless of the ratio R, the minimum dimension L_{MD} for the feature can be (i) the diameter of the smallest circle that fully encloses the feature or (ii) the diameter of the largest circle that fits fully within the feature.

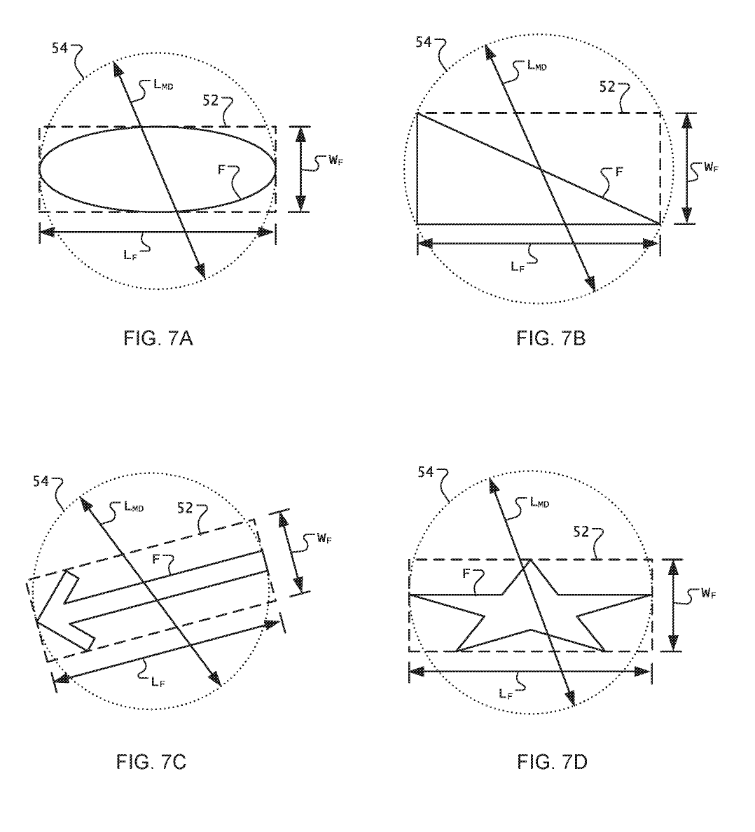

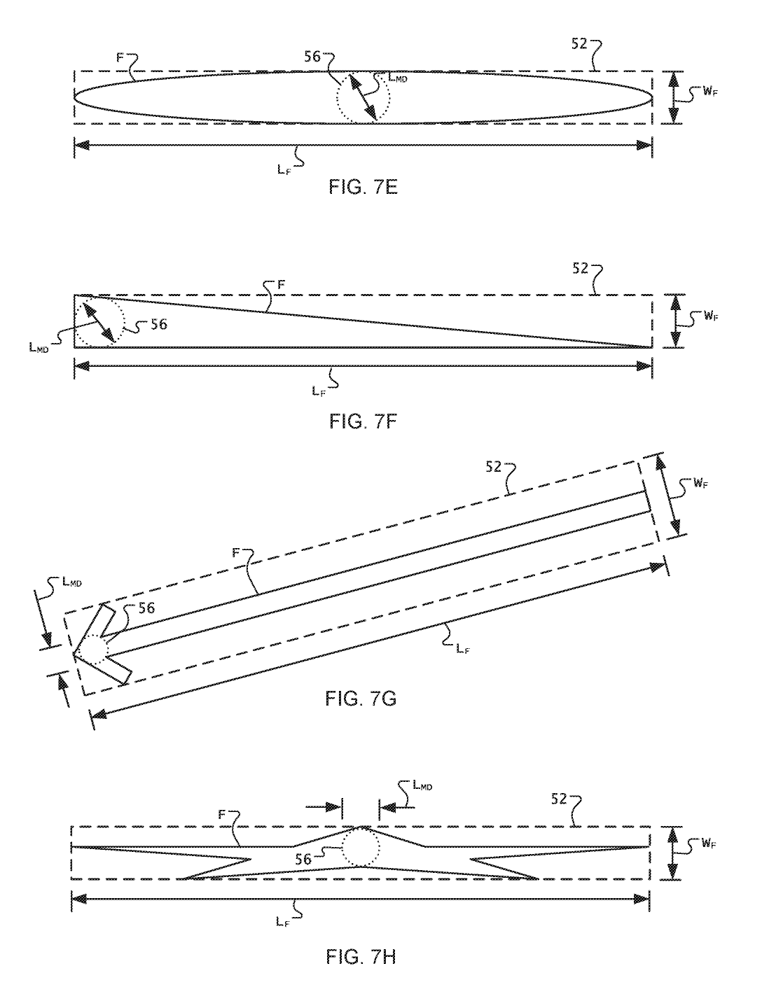

FIGS. 7A-7H depict the length L_{F}, width W_{F}, and minimum dimension L_{MD} for a plurality of exemplary features F. In each figure, a tight-fitting rectangle 52 is drawn around the feature F, such that a longest side of the rectangle 52 is parallel and equal to the length L_{F} and a shortest side of the rectangle 52 is parallel and equal to the width W_{F}, which is orthogonal to the length L_{F}. The features F depicted in FIGS. 7A-7D are considered to be compact (e.g., the ratio R=L_{F}/W_{F} is less than or equal to the threshold value) and the minimum dimension L_{MD} is equal to a diameter of a smallest circle 54 that fully encloses the feature. The features F depicted in FIGS. 7E-7H are considered to not be compact (e.g., the ratio R=L_{F}/W_{F} is greater than the threshold value) and the minimum dimension L_{MD} is equal to a diameter of a largest circle 56 that fits fully within the feature F. While the features F depicted in FIGS. 7A-7H are ellipses, triangles, arrows, and stars, the same approach for determining the minimum dimension L_{MD} can be used for other shapes.

In preferred examples, the adhesive patterns can be printed over an entire surface of the release paper, for example, across an entire width of the release paper web with few or no gaps in the patterns. Within a given printed area of the release paper, the adhesive can cover from about 40% to about 75% of the printed area, though higher or lower adhesive coverages can be used.

In some examples, the features can be arranged randomly (e.g., not in a grid) and/or can have varying sizes and/or shapes within the adhesive pattern. A pattern can include, for example, circular features having diameters ranging from about 0.25 mm to about 10 mm. Alternatively or additionally, a printed adhesive pattern can have a mixture of different feature types (e.g., any mixture of circles, diamonds, rhombuses, lines, and triangles). With a rotary printing press, the printed adhesive pattern will generally repeat with each revolution of a plate cylinder (e.g., the gravure roll 20).

FIG. 4 illustrates an example adhesive pattern 60 formed with discrete square or diamond features 62, which are arranged in a grid. Each square feature 62 has a length and a width of L₁ and is separated from adjacent square features 62 by a distance L₂. In various examples, L₁ can be about 0.75 mm, about 1.5 mm, about 3 mm, or can be any value from about 0.25 mm to about 10 mm. L₂ can be, for example, about 0.25 mm, about 0.5 mm, about 1 mm, about 2 mm, or can be any value from about 0.1 mm to about 5 mm. Regions 64 between the square features 62 are preferably connected or contiguous and form a crisscrossing or lattice pattern. In some instances, the square features 62 are formed with adhesive. Alternatively, the square features 62 can be defined by openings in the adhesive, such that the adhesive forms the regions 64 between the square features 62.

FIG. 5 illustrates an example adhesive pattern 70 formed with discrete circular features 72. The circular features 72 are arranged in rows, such that each circular feature 72 has six nearest neighboring circular features 72. Each circular feature 72 has a diameter L₃, which can be, for example, about 1 mm, about 3.5 mm, about 7 mm, or any value from about 0.25 mm to about 10 mm. Each row of circular features 72 is separated from an adjacent row by a distance L₄. L₄ can be, for example, about 1.25 mm, about 4.35 mm, or any value from about 0.5 mm to about 10 mm. Within each row, circular features 72 are separated by a gap L₅ and a center-to-center distance L₆. L₅ can be, for example, about 0.5 mm, about 1.5 mm, or any value from about 0.25 mm to about 5 mm. L₆ can be, for example, about 1.5 mm, about 5 mm, or any value from about 0.5 mm to about 10 mm. In some instances, the circular features 72 are formed with adhesive. Alternatively, the circular features 72 can be defined by openings in the adhesive, such that the adhesive forms connected or contiguous regions 74 between the circular features 72. In the depicted example, the circular features 72 cover about 45% of the pattern.

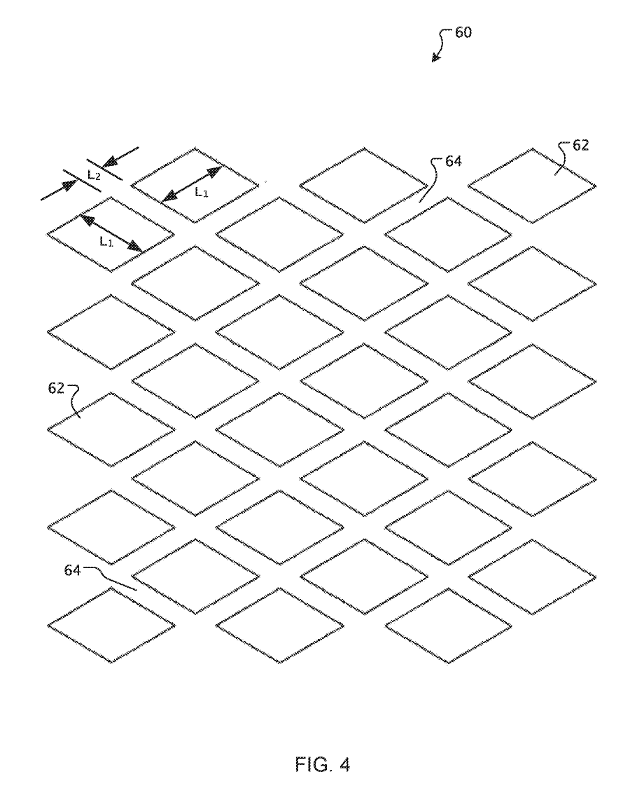

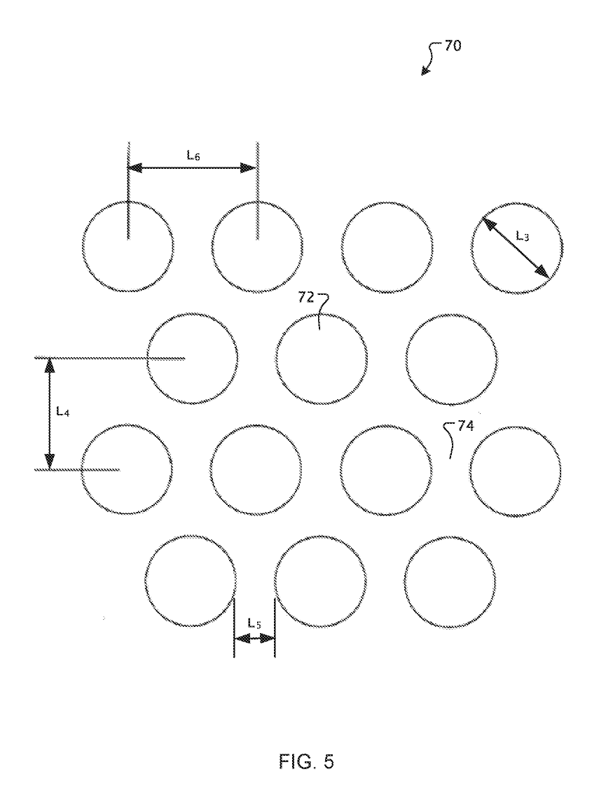

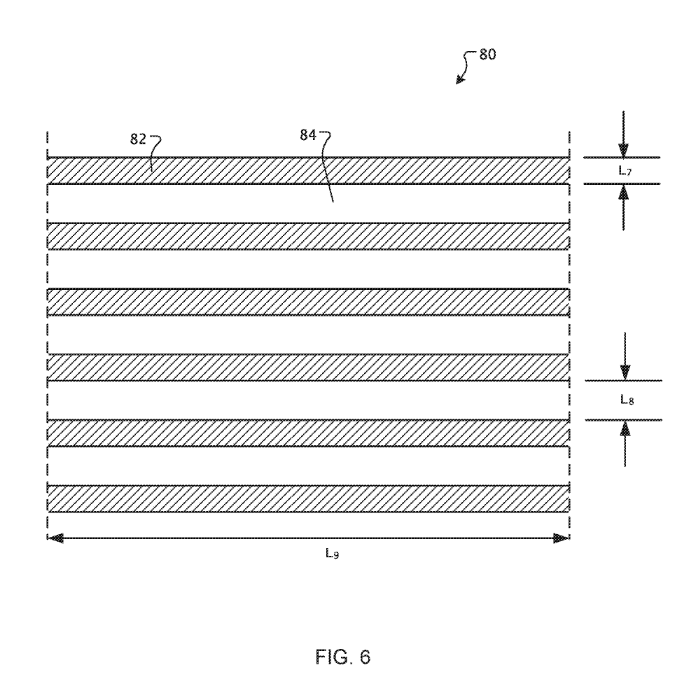

FIG. 6 illustrates an example adhesive pattern 80 formed with discrete parallel line features 82. Each line feature 82 has a width L₇ and is separated from adjacent lines by a distance L₈. L₇ can be, for example, about 0.5 mm, about 1 mm, about 2 mm, about 5 mm, or any value from about 0.25 mm to about 10 mm. L₈ can be, for example, about 1 mm, about 2 mm, about 4 mm, or any value from about 0.5 mm to about 10 mm. The line features 82 in this example are preferably formed with adhesive, while regions 84 between the lines preferably include no adhesive and/or represent openings in the adhesive. A length L₉ of the line features 82 can be, for example, from about 10 mm to about 1,000 mm or more. In some examples, the line features 82 are straight or curved (e.g., wavy) and/or can be aligned in a direction that is perpendicular or parallel to a web travel direction, or angled (e.g., 45 degrees) relative to the web travel direction.

In various examples, the adhesive patterns described herein can be used to form bonds between a wide variety of substrate materials. The substrates can be, for example, materials for garment components, such as natural fabric materials (e.g., cotton or wool) and/or synthetic fabric materials (e.g., polypropylene, polyester, or nylon). The garment components can be, for example, waistbands, cuffs, pockets, mesh sections, and/or bra wings/panty components. Garment types can include, for example, athletic sportswear (e.g., running clothes or yoga clothes), technical outerwear (e.g., ski jackets), and lingerie (e.g., bras and panties).

Additionally or alternatively, a wide range of adhesive patterns can be printed and used, including repeating geometric patterns (e.g., as shown in FIGS. 4-6), randomized decorative patterns, company logo shapes or patterns, and/or shapes for bonding pockets, zippers, hoods, etc. When used to make garments, the adhesive patterns advantageously add breathability and softness, while maintaining wash and dry requirements and peel force. In some examples, the combination of the fabric and the adhesive pattern can influence modulus and/or recovery. Unlike solid adhesive films, for example, which can restrict movement of fabric layers in or around bond regions, the patterned adhesive allows the fabric to stretch and recover. Additionally or alternatively, the modulus and/or recovery can be influenced by the directionality of the pattern when bonding, as well as the specific fibers that are bonded. Some patterns may display a higher or lower modulus when pulled in a certain direction, which can influence the modulus of a bonded application. For example, when using an adhesive pattern of parallel lines, the modulus may be different (e.g., higher) in a direction parallel to the lines compared to a direction perpendicular to the lines. In some applications, the pattern may have some visibility on the garment, so design aesthetics can also be improved. Further, breathability of bond regions can be improved, due to openings in the adhesive patterns, which can readily permit the passage of air or water vapor through the bond regions.

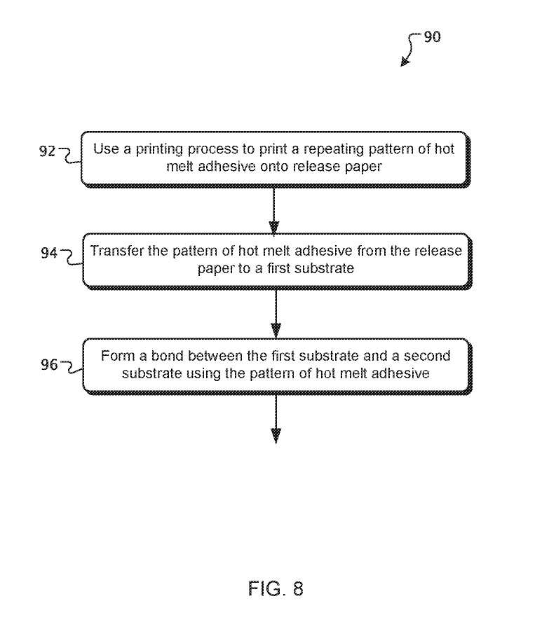

FIG. 8 is a flowchart of an example method 90 of forming an adhesive bond between two substrates. A printing process (e.g., a gravure process) is used to print (step 92) a repeating pattern of hot melt adhesive onto release paper. In preferred examples, the repeating pattern defines a plurality of discrete features (e.g., adhesive regions or non-adhesive regions), with each feature having a minimum dimension or characteristic length in a range up to about 10 mm. The pattern of hot melt adhesive is transferred (step 94) from the release paper to a first substrate. A bond is formed (step 96) between the first substrate and a second substrate using the pattern of hot melt adhesive.

In various examples, the adhesive patterns include openings (i.e., non-adhesive regions) that cover from about 25% to about 60% of either (i) a printed area on the release paper or (ii) a bonded area between two substrates. The adhesive patterns can have a film thickness from about 0.002 inches to about 0.008 inches or from about 0.004 inches to about 0.006 inches. The adhesive patterns can have a weight per area from about 25 g/m² to about 75 g/m² (excluding the weight of the release paper or substrate). The adhesive patterns can achieve a peel adhesion strength from about 1.5 lbs to about 6.0 lbs on 25 mm width specimens, when peeled at 12 in/min, according to ASTM D3330/D3330M and D903. Modulus and recovery values for bonded specimens having a 25 mm width and pulled at 20 in/min, according to ASTM D412, are shown in Table 3. Garment materials bonded with the adhesive patterns are preferably able to pass a wash resistance test involving 20 cycles of a 40° C. wash (e.g., in a washing machine) followed by a low temperature dry (e.g., at around 52° C.).

TABLE 3
Modulus and recovery values.

| Property | Value |
|---|---|
| Modulus at 10% elongation | 0.8 lbs-2.5 lbs |
| Modulus at 30% elongation | 2.0 lbs-4.0 lbs |
| Recovery | 90-98% |

In certain implementations, the openings in the adhesive patterns can provide passages for the flow of air, water vapor, and/or other fluids through the bonded area. A maximum breathability can occur when the openings occupy close to 100% of the bonded area. In that case, the breathability of the bonded area can approach or be equal to the breathability of the two substrate materials. By contrast, a minimum breathability can occur when the openings occupy close to 0% of the bonded area. In that case, the breathability of the bonded area can depend on a breathability of the hot melt adhesive. If the adhesive has little or no breathability, for example, the breathability of the bonded area can approach or be equal to zero. In general, the breathability of the bonded area can increase (e.g., linearly) as the percentage of bonded area occupied by the openings is increased. When the openings occupy 50% of the bonded area, for example, the breathability of the bonded area can be about 50% of the breathability of the two substrate materials, particularly if the adhesive has little or no breathability. In one example, two layers of unbonded fabric were measured to have an air permeability of about 26 CFM (cubic feet per minute). When the two fabric layers were bonded together using an adhesive pattern in which the openings occupied 40% of the bonded area, the permeability was measured to be about 8 to 12 CFM.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method of printing an adhesive material, the method comprising:
using a printing process to print a repeating pattern of hot melt adhesive onto a release paper,
wherein the repeating pattern defines a plurality of discrete features, each feature comprising a minimum dimension in a range up to about 10 mm.

2. The method of claim 1, wherein the printing process comprises use of a gravure roll comprising cells that define the repeating pattern.

3. The method of claim 1, wherein the features comprise at least one of adhesive regions and openings.

4. The method of claim 1, wherein the hot melt adhesive comprises at least one of a thermoplastic polyurethane, a co-polyester, a polyolefin, a thermoplastic rubber, and a polyamide.

5. The method of claim 1, wherein the repeating pattern comprises a grid pattern.

6. The method of claim 1, wherein the features comprise at least one of rectangles, squares, diamonds, circles, triangles, and ovals.

7. The method of claim 1, wherein the features are defined by a plurality of parallel lines of the adhesive.

8. The method of claim 1, wherein the hot melt adhesive covers from about 40% to about 75% of a printed area.

9. The method of claim 1, wherein the release paper comprises at least one of a silicone coated release paper, a clay coated paper, and a plastic release liner comprising at least one of polyethylene, polypropylene, and polyester.

10. The method of claim 1, wherein the release paper comprises a continuous web.

11. An adhesive material manufactured according to the method of claim 1.

12. An adhesive material comprising:
a release paper; and
a repeating pattern of hot melt adhesive disposed on the release paper,
wherein the repeating pattern defines a plurality of discrete features, each feature comprising a minimum dimension in a range up to about 10 mm.

13. The adhesive material of claim 12, wherein the release paper comprises at least one of a silicone coated release paper, a clay coated paper, and a plastic release liner comprising at least one of polyethylene, polypropylene, and polyester.

14. The adhesive material of claim 12, wherein the features comprise at least one of adhesive regions and openings.

15. The adhesive material of claim 12, wherein the hot melt adhesive comprises at least one of a thermoplastic polyurethane, a co-polyester, a polyolefin, a thermoplastic rubber, and a polyamide.

16. The adhesive material of claim 12, wherein the repeating pattern comprises a grid pattern.

17. The adhesive material of claim 12, wherein the features comprise at least one of rectangles, squares, diamonds, circles, triangles, and ovals.

18. The adhesive material of claim 12, wherein the features are defined by a plurality of parallel lines of the adhesive.

19. The adhesive material of claim 12, wherein the hot melt adhesive covers from about 40% to about 75% of a surface of the release paper.

20. The adhesive material of claim 12, wherein the release paper comprises a continuous web.

21. A method of forming a breathable adhesive bond, the method comprising:
transferring a pattern of hot melt adhesive from a release paper to a first substrate; and
forming a bond between the first substrate and a second substrate with the pattern of hot melt adhesive,
wherein the pattern defines a plurality of discrete features, each feature comprising a minimum dimension in a range up to about 10 mm.

22. A garment manufactured using the method of claim 21.

23. A garment comprising:
a first garment layer;
a second garment layer; and
a pattern of hot melt adhesive bonding the first and second garment layers,
wherein the pattern defines a plurality of discrete features, each feature comprising a minimum dimension in a range up to about 10 mm.

24. The garment of claim 23, wherein at least one of the first and second garment layers comprises a fabric material.
